(19) United States
(12) Patent Application Publication
(10) Pub. No.: US 2026/0240184 A1
(43) Pub. Date: Aug. 20, 2026

(54) PLANT-BASED CHEESE COMPOSITION

(71) Applicant: TIENSE SUIKERRAFFINADERIJ N.V., Tienen (BE)

(72) Inventor: Frank Soetaerts, Tienen (BE)

(21) Appl. No.: 19/160,776

(22) PCT Filed: Feb. 28, 2024
(86) PCT No.: PCT/EP2024/055054

§ 371 Date: Aug. 28, 2025

(30) Foreign Application Priority Data
Mar. 2, 2023 (EP) 23159778.2
Apr. 14, 2023 (EP) 23167943.2

(51) Int. Cl. A23C 20/02

(52) U.S. Cl. CPC A23C 20/02; A23C 2240/15

(57) ABSTRACT

The present invention relates to plant-based cheese compositions, as well as a preparation method of such plant-based cheese compositions, relying on the combination of 10 to 40 wt. % of a plant-based mixture of fatty acid triglycerides, at least 4 wt. % inulin, and at least 1 wt. % of a starch and/or flour. The present invention further relates to food products comprising such plant-based cheese compositions.

The present invention relates to plant-based cheese compositions, as well as a preparation method of the plant-based cheese compositions. The present invention further relates to food products comprising the plant-based cheese compositions.

Consumers are increasingly leaning towards ways to reduce, eliminate or substitute products originating from livestock in their diets, there is an increasing demand for vegan products. The main challenge in developing such substitute products is to create a product with the desired sensory characteristics associated with traditional cheeses, while maintaining a healthy nutritional profile.

US20210120834A1 discloses a plant-based or vegan cheese composition, comprising water in an amount of 40-55 wt. % of the total weight of the vegan cheese; vegetable oils and fats in an amount of 20-25 wt. % of the total weight of the vegan cheese, and starch in an amount of 10-30 wt. % of the total weight of the vegan cheese, and a method for preparing the same. A vegan cheese having the characteristics of mozzarella cheese is further disclosed.

A disadvantage of plant-based or vegan cheese compositions known in the art is that they are limited to only a very limited range of textures and other sensory characteristics associated with different types of cheeses.

It is an object of the present invention to provide plant-based or vegan cheese compositions having the desired sensory characteristics associated with a range of different types of traditional cheeses, while maintaining a desirable nutritional profile.

This result is achieved by a plant-based cheese composition comprising:
50 to 85 wt. % water;
10 to 40 wt. % of a plant-based mixture of fatty acid triglycerides;
at least 1 wt. % of a starch and/or flour; and
at least 4 wt. % inulin.

It was found that a combination of inulin, a starch and/or flour, and fatty acid triglycerides can lead to plant-based cheeses with different textures and sensory characteristics.

Inulin is a fructan-type carbohydrate, consisting mostly of fructose units, which occurs in many plants as a reserve carbohydrate. Inulin can be produced by certain bacteria and can also be enzymatically produced in vitro from sucrose.

Inulin naturally occurs as a polydisperse mixture of molecules which are composed of fructosyl units forming linear chains in which the fructosyl units are linked to one another mainly by a β(2,1) bound. Said linear chains are possibly bearing one or more side chains essentially composed of fructosyl units, thus forming branched inulin molecules with a fructosyl-fructosyl linkage at the branching point, said linkage being commonly formed by a fructosyl-fructosyl β(2,6) bound. Inulin molecules from plant origin mostly contain one terminal glucosyl unit. Accordingly, inulin molecules can be represented by the formula GFₙ or Fₘ wherein G represents a terminal glucosyl unit, F represents a fructosyl unit and n and m represent the number of fructosyl units linked to one another through a β(2,1) and/or a β(2,6) bound. The number n+1, respectively m, indicates the degree of polymerization of the inulin molecule.

Inulin is further characterized by its average degree of polymerization, represented by D̅P̅. As meant herein, the determination of the average degree of polymerization D̅P̅ in compositions containing inulin is based on AOAC Official Method 997.08 (2013 version, AOAC International):
As is known, this method first requires the determination of non-inulin related glucose and non-inulin related fructose in the composition: free glucose and fructose concentrations, as well as the concentrations of glucose and fructose deriving from sucrose, starch and/or maltodextrines present in the inulin-containing composition are determined.
An inulinase treatment of the inulin-containing composition will result in complete enzymatic hydrolysis of the inulin compounds into free glucose and free fructose.
Subtracting the earlier-determined non-inulin related concentrations of glucose and fructose from the overall fructose and glucose content determined after complete enzymatic hydrolysis of the inulin composition to be analyzed provides the concentrations, in particular weight-percentages, of inulin-related fructose (Fᵢ) and inulin-related glucose (Gᵢ).

If the inulin in the composition consists essentially of GFₙ compounds, the average degree of polymerization D̅P̅ can be calculated via the formula as given in AOAC 997.08:

$$\overline{DP} = [ ( {F}_{i} / {G}_{i} ) + 1 ] \qquad ( 1 )$$

If the inulin in the composition is an inulin product that has undergone a partial hydrolysis, for example by treatment with an endo-inulinase, it no longer consists essentially only of GFₙ compounds but also has an amount of Fₘ compounds. Formula (1) is then no longer sufficiently accurate, and a correction is needed. AOAC 997.08 provides approximations for this correction.

Native inulin from plant sources (i.e. the inulin as present in the plant) appears as a polydisperse mixture of mostly linear polysaccharide chains with a D̅P̅ ranging from 2 to about 100, whereas inulin molecules from bacterial origin usually have much higher D̅P̅ values, even up to about 115 000. Plant inulin has a D̅P̅ which largely depends on the plant source and on the harvest, storage and processing conditions. Inulin with a D̅P̅ above or equal to 20 is termed herein long-chain inulin whereas inulin with a D̅P̅ above 8 and below 20 is termed herein medium-chain inulin.

It was found in a preferred main embodiment that the use of long-chain and medium-chain inulin can lead to the desired sensory characteristics of the plant-based cheese. In embodiments of the invention, the inulin has an average degree of polymerization D̅P̅ from 8 to 60, preferably from 12 to 50, more preferably from 15 to 40.

According to the invention, the desired sensory characteristics of the plant-based cheese can be present when the amount of inulin, relative to the total plant-based cheese composition, is at least 4 wt. %. Different textures and other desirable sensory characteristics may be obtained in preferred embodiments by varying the amount of inulin up to about 15 wt. %. In useful embodiments, the present invention provides a plant-based cheese composition as defined herein, comprising less than about 15 wt. % inulin, preferably from 5 to 15 wt. % inulin, more preferably from 6 to 12 wt. %, even more preferably from 7 to 10 wt. % inulin. In a particular embodiment, the present invention provides a plant-based cheese composition as defined herein, wherein the inulin has an average degree of polymerization D̅P̅ from 8 to 60, preferably from 12 to 50, more preferably from 15 to 40; and comprising at least 4 wt. % inulin and less than about 15 wt. % inulin, preferably from 5 to 15 wt. % inulin, more preferably from 6 to 12 wt. %, even more preferably from 7 to 10 wt. % inulin.

According to the invention, the desired sensory characteristics of the plant-based cheese can be obtained when the combined amount of starch and/or flour, relative to the total plant-based cheese composition, is at least 1 wt. %. To obtain a desirable nutritional profile, the amount of starch and/or flour may be suitably varied. In certain embodiments, the present invention provides a plant-based cheese composition as defined herein, comprising a combined amount of starch and/or flour of less than about 20 wt. %, preferably from 2 to 20 wt. %, more preferably from 3 to 15 wt. %, even more preferably from 4 to 12 wt. %.

Suitable starches and/or flours may be based on plant sources such as, but not limited to, cereals like rice, wheat, and maize, root vegetables like potatoes and cassava, and beans like faba beans. Suitable starches and/or flours are based on plant sources.

Suitable starches are selected from tapioca starch, wheat starch, potato starch, rice starch, faba bean starch, corn starch and any combination thereof. According to embodiments of the invention, indica-type rice starch is particularly suited to obtain a plant-based cheese composition with desirable properties. Without being bound by theory, indica-type rice starch may provide a shorter, non-elastic texture of the plant-based cheese composition. Suitably, the starch in the plant-based cheese composition may include starch from any native source, wherein native indicates a starch in essentially the form as found in nature. The starch may also be at least partly gelatinized. Processes for pregelatinizing starch are generally known. Starch gelatinization is a process of breaking down the intermolecular bonds of starch molecules in the presence of water and heat, allowing the hydrogen bonding sites to engage more water. This process irreversibly dissolves the starch granule in water, where water may act as a plasticizer. The pregelatinized starch is generally dried before being packed and transported. Pregelatinized starch may readily be dissolved in cold water. Pregelatinized starch may be derived from native starch, from chemically crosslinked starch, or from physically modified starch. The term physically modified starch includes starches that have been subjected to a heat/moisture treatment, to annealing, to thermal inhibition, and the like. As meant herein the term physically modified does not encompass pregelatinization. Chemically modified and physically modified starches are known to provide a high process tolerance, which makes them suitable as food thickeners or stabilizers under more extreme process conditions. As is known, the gelatinization temperature of starch depends upon plant type and the process conditions used. Some types of unmodified native starches start swelling at 55° C., other types at 85° C. The gelatinization temperature of modified starch depends on, for example, the degree of cross-linking, acid treatment, or acetylation. In embodiments of the invention, the starch is selected from tapioca starch, wheat starch, potato starch, rice starch, faba bean starch, corn starch or any combination thereof, preferably the starch is rice starch, faba bean starch, or any combination thereof; more preferably the starch is indica-type rice starch, faba bean starch, or any combination thereof. Suitable flours may be selected from the group consisting of tapioca flour, wheat flour, potato flour, rice flour, faba bean flour, corn flour and any combination of two or more thereof. Preferably, the flour is selected from the group consisting of rice flour, faba bean flour, and any combination thereof. More preferably, the flour is a rice flour.

The term ‘a plant-based mixture of fatty acid triglycerides’ is used herein to include any single vegetable oil or any mixture of two or more vegetable oils. Furthermore, the vegetable oil or oils may have been further processed, such as, but not limited to, refining, bleaching, deodorization, partial or full hydrogenation, homogenization, or any combination thereof.

Vegetable oils can be derived or extracted from different plant sources, such as, but not limited to, flowers, fruits, vegetables, nuts, seeds, and the like, and are typically also named as such. Vegetable oils typically have a content of over 95 wt. % fatty acid triglycerides, with other minor components. It is known that the fatty acids of those fatty acid triglycerides typically have from 6 to 24 carbon atoms, and wherein each of the fatty acids can have 1 or more double bonds ranging from 0 (saturated, e.g. C18 or C18:0), over 1 (mono-unsaturated, e.g. C18:1), to 2 or more double bonds (poly-unsaturated, e.g. C18:2, C18:3). These double bonds are typically in the cis-configuration. Fatty acids with less than 6 carbon atoms are typically considered short-chain fatty acids, those with 6-12 carbon atoms are typically considered medium-chain fatty acids, those with 13-21 carbon atoms are typically considered long-chain fatty acids, and those with 22 or more carbons are typically considered very-long-chain fatty acids.

It is known that the number of carbon atoms has an influence on the melting point, in the sense that when a fully saturated C12 fatty acid triglyceride—in essence a fatty acid triglyceride comprising 3 saturated lauric acid groups—is compared with a fully saturated C14 fatty acid triglyceride, the latter will have a higher melting point. The degree of unsaturation may also have an influence on the melting point, in the sense that when a fully saturated C18 fatty acid triglyceride is compared with an unsaturated C18 fatty acid triglyceride—in essence a fatty acid triglyceride comprising 3 fatty acid groups independently selected from C18:0, C18:1, C18:2, and C18:3, with up to 2 groups being C18:0—the unsaturated fatty acid triglyceride will have a lower melting point. For sake of completeness, it should also be noted that each of the 3 fatty acids of a fatty acid triglyceride can have a different carbon chain length, for instance a fatty acid comprising 1 palmitic acid (C16:0) group, 1 stearic acid (C18:0) group, and 1 oleic acid (C18:1) group.

Because most vegetable oils, such as sunflower oil, olive oil, rapeseed oil, have a high content of unsaturated fatty acids, relative to the total amount of fatty acids, they typically have a melting point below 0° C. There are however vegetable oils that are solid at room temperature, due to a low content of unsaturated fatty acids and/or to the presence of long-chain fatty acids, relative to the total amount of fatty acids. Coconut oil for instance has a melting point of 25° C., is about 90 wt. % composed of saturated fatty acids—of which lauric acid (C12) is most predominantly present—and only about 10 wt. % of unsaturated fatty acids. Palm oil has a melting point of about 36° C., has a saturated fatty acid content of about 50 wt. %—and thus about 50 wt. % of unsaturated fatty acids—and is predominantly composed of palmitic acid (C16). Both examples show the influence of the interplay of the degree of unsaturation and the length of the carbon chain of the fatty acids on the melting point of a plant-based mixture of fatty acid triglycerides.

A plant-based mixture of fatty acid triglycerides with a specific content of saturated fatty acids, relative to the total amount of fatty acids, can be obtained by hydrogenation or hardening, by making a mixture of two or more different vegetable oils, or any combination thereof. Hydrogenation can be performed until substantially all double bonds are saturated, also called full hydrogenation or hardening. Hydrogenation can alternatively be performed so that only a part of the double bonds are saturated, also called partial hydrogenation or hardening. When hydrogenation is performed on a vegetable oil, double bonds present in the fatty acid triglycerides, naturally occurring in the cis-configuration, may get isomerized into the trans-configuration. In the case of partial hydrogenation, these double bonds in the trans-configuration may remain in the hydrogenated vegetable oil, while they get further hydrogenated during full hydrogenation.

It was found that different mixtures of plant-based fatty acid triglycerides may be suitably used to obtain a plant-based cheese with desirable characteristics.

It was further found that the desired sensory characteristics of the plant-based cheese may be obtained when at least about 10 wt. % and up to about 40 wt. % of a plant-based mixture of fatty acid triglycerides, relative to the total plant-based cheese composition, is present in the plant-based cheese composition. The amount of the plant-based mixture of fatty acid triglycerides may be further varied, thereby leading to different sensory characteristics and/or nutritional profiles. In yet other embodiments of the invention, a plant-based cheese composition as defined herein is provided, comprising from 12 to 38 wt. % of a plant-based mixture of fatty acid triglycerides, preferably from 15 to 35 wt. %.

It was found that a higher saturated fatty acid content in the plant-based mixture of fatty acid triglycerides typically leads to a firmer cheese, while a lower saturated fatty acid content typically leads to a more spreadable plant-based cheese. According to another embodiment of the invention, a saturated fatty acid content, relative to the total fatty acid content, in the plant-based mixture of fatty acid triglycerides of at least about 20 wt. % is particularly suited to obtain the desired firmness and spreadability characteristics of the plant-based cheese. Hence, in yet another embodiment, the present invention provides a plant-based cheese composition as defined herein, wherein the saturated fatty acid content of the plant-based mixture of fatty acid triglycerides, relative to the total fatty acid content, is at least 20 wt. %, preferably at least 30 wt. %, more preferably at least 40 wt. %, even more preferably at least 50 wt. %, yet even more preferably from 60 to 95 wt. %, most preferably from 70 to 90 wt. %.

It was further found that the addition of a vegetable protein to the plant-based cheese composition may have a beneficial effect on the desired sensory characteristics and/or the nutritional profile of the plant-based cheese. In an embodiment, the vegetable protein may be suitably added in an amount, relative to the total plant-based cheese composition, of about 0.5 wt. % up to about 10 wt. %. In another embodiment, the present invention provides a plant-based cheese composition as defined herein, further comprising from 0.5 to 10 wt. % of a vegetable protein, preferably from 1 to 8 wt. %, more preferably from 2 to 6 wt. %, even more preferably from 3 to 5 wt. % of a vegetable protein.

Vegetable proteins may be based on plant sources such as, but not limited to, chickpeas, lentils, nuts and seeds, peas, beans, such as faba beans, rice, flour, and the like. Suitable plant proteins may be selected from pea protein, soybean protein, peanut protein, sesame protein, walnut protein, rice protein, faba bean protein, fava protein, or any combination thereof. In embodiments of the invention, the vegetable protein is selected from pea protein, soybean protein, peanut protein, sesame protein, walnut protein, rice protein, faba bean protein, fava protein, or any combination thereof, preferably wherein the vegetable protein is rice protein, faba bean protein, or any combination thereof.

In a specific embodiment, the present invention provides a plant-based cheese composition as defined herein, comprising from 12 to 38 wt. % of a plant-based mixture of fatty acid triglycerides, relative to the total plant-based cheese composition, preferably from 15 to 35 wt. %; comprising less than about 15 wt. % inulin, preferably from 5 to 15 wt. % inulin, more preferably from 6 to 12 wt. %, even more preferably from 7 to 10 wt. %; comprising a combined amount of starch and/or flour of less than about 20 wt. %, preferably from 2 to 20 wt. %, more preferably from 3 to 15 wt. %, even more preferably from 4 to 12 wt. %; and further comprising from 0.5 to 10 wt. % of a vegetable protein, preferably from 1 to 8 wt. %, more preferably from 2 to 6 wt. %, even more preferably from 3 to 5 wt. %.

In another specific embodiment, the present invention provides a plant-based cheese composition as defined herein, comprising:
50 to 85 wt. % water;
10 to 40 wt. % of a plant-based mixture of fatty acid triglycerides;
at least 1 wt. % of a flour; and
at least 4 wt. % inulin.

It was found that a combination of inulin, flour and fatty acid triglycerides according to the specific embodiment may result in a texture that is particularly suitable for soft, spreadable plant-based cheese compositions.

In a more specific embodiment, the present invention provides a plant-based cheese composition as defined herein, comprising
from 12 to 38 wt. % of a plant-based mixture of fatty acid triglycerides, relative to the total plant-based cheese composition, preferably from 15 to 35 wt. %;
less than about 15 wt. % inulin, preferably from 5 to 15 wt. % inulin, more preferably from 6 to 12 wt. %, even more preferably from 7 to 10 wt. %;
less than about 20 wt. % of a flour, preferably from 2 to 20 wt. %, more preferably from 3 to 15 wt. %, even more preferably from 4 to 12 wt. %; and
from 0.5 to 10 wt. % of a vegetable protein, preferably from 1 to 8 wt. %, more preferably from 2 to 6 wt. %, even more preferably from 3 to 5 wt. %;
   wherein preferably, the flour is a rice flour.

While it may be preferred that the plant-based cheese does not contain preservatives, synthetic flavorants, colorants, and the like, leading to so-called ‘clean label’ products, other embodiments of the plant-based cheese composition may contain up to about 5 wt. %, relative to the total plant-based cheese composition, of flavoring agents, colorants, stabilizers, emulsifiers, or any combination thereof. In yet another embodiment, the present invention provides a plant-based cheese composition as defined herein, wherein the flavoring agent is selected from salt, sugar, aspartame, acesulfame potassium, sucralose, or any combination thereof.

The plant-based cheese composition as defined herein is particularly suited to have characteristics very similar to, or even virtually identical to, dairy-based cheeses such as spreadable cheeses, such as a cream cheese, or a Kiri cheese, semi-soft cheeses such as a Camembert cheese, and brittle and cuttable cheeses such as a feta cheese. According to useful embodiments, therefore, the present invention provides a plant-based cheese composition as defined herein, wherein the plant-based cheese is a spreadable cheese, a soft cheese, a semi-soft cheese, a firm cheese, or a brittle cheese.

Another aspect of the invention provides a method for the preparation of a plant-based cheese composition as defined herein, comprising the steps of:
a) stirring a mixture of the plant-based mixture of fatty acid triglycerides, the starch and/or flour, the inulin, and optionally the vegetable protein, flavoring agents, colorants, stabilizers, emulsifiers and/or other additives in water at a temperature of at least 10° C., and above the melting point of the plant-based mixture of fatty acid triglycerides, thereby providing an emulsion;
b) homogenizing the emulsion by subjecting the emulsion to shear forces, thereby providing a homogenized emulsion;
c) optionally hot filling the homogenized emulsion in a mold; and
d) cooling down the homogenized emulsion, thereby providing a plant-based cheese composition.

The method mentioned hereinbefore is particularly suited to provide plant-based compositions having desirable sensory characteristics.

It was further found that stirring the mixture in step a) at a temperature of at least 10° C., or of at least the melting point of the plant-based mixture of fatty acid triglycerides in case the said melting point is higher than 10° C., is particularly suited to obtain a homogeneous emulsion. The inventors also found that stirring the mixture in step a) at a further elevated temperature may have a beneficial effect on the properties of the plant-based cheese composition. The further elevated temperature may for instance lead to gelatinization of the starch and/or flour. In an embodiment, the present invention provides a method for the preparation of a plant-based cheese composition, as defined herein, wherein stirring the mixture in step a) is performed at a temperature of at least 20° C., preferably at least 30° C., more preferably from 40 to 90° C., even more preferably at a temperature from 50 to 80° C.

It was further found that homogenizing the emulsion obtained in step a) by subjecting the emulsion to shear forces may have a beneficial effect on the properties of the plant-based cheese product. Homogenization is a known technique in the art and can for instance be applied through a rotor-stator homogenizer, a high-pressure homogenizer, or the like. In a particular embodiment, the present invention provides a method for the preparation of a plant-based cheese composition, as defined herein, wherein homogenization in step b) is performed by applying shear forces to the emulsion with a high-pressure homogenizer at a pressure from 100 to 250 bar, at an elevated temperature, preferably from 40° C. to 70° C.,

It was further found that adding the plant-based mixture of fatty acid triglycerides to the water before adding the other components may have a positive effect on the desired sensory characteristics of the plant-based cheese. In an embodiment, the present invention provides a method for the preparation of a plant-based cheese composition, as defined herein, wherein in step a) the mixture in water is prepared by first adding the plant-based mixture of fatty acid triglycerides to the water, thereby obtaining a pre-mixture, followed by adding the starch and/or flour, the inulin, and optionally the vegetable protein, flavoring agents, colorants, stabilizers, emulsifiers and/or other additives to the pre-mixture so as to obtain the mixture in water.

When the plant-based mixture of fatty acid triglycerides is solid at room temperature, it turned out to be beneficial according to the invention to melt the plant-based mixture of fatty acid triglycerides before adding it to the water.

It was also found by the inventors that mixing the further ingredients, i.e. the ingredients besides the plant-based mixture of fatty acid triglycerides, before adding them to the water can improve the homogeneity of the resulting emulsion. In an embodiment of the method according to the invention, the starch and/or flour, the inulin, and optionally the vegetable protein, flavoring agents, colorants, stabilizers, emulsifiers and/or other additives, are mixed to form an inulin/starch and/or flour mixture. The inulin/starch and/or flour mixture is subsequently added to the water or, more preferably, to the pre-mixture.

It was further found that adjusting the pH of the emulsion obtained in step a) may be beneficial for the stability of the emulsion. In yet another embodiment, the present invention provides a method for the preparation of a plant-based cheese composition, as defined herein, comprising the step of adjusting the pH of the emulsion to from 4.0 to 5.5. Depending on the pH of the emulsion obtained in step a), an acid or a base can be used. Any food-suitable base or acid may be used to this end. In case an acid is used in adjusting the pH, it is preferred to use lactic acid.

It was further found that a heat treatment, such as for example pasteurization, of the emulsion or the homogenized emulsion may be beneficial to control any microbial contamination. In yet another embodiment, the present invention provides a method for the preparation of a plant-based cheese composition, as defined herein, further comprising the step of heat-treating of the emulsion and/or the homogenized emulsion.

In a particular embodiment of the invention, the plant-based cheese composition may be prepared under clean room conditions to avoid or minimize microbial contamination, thereby possibly reducing or even eliminating the applicability of a heat treatment such as pasteurization.

In an embodiment, the present invention provides a method for the preparation of a plant-based cheese composition, as defined herein, wherein the emulsion comprises:
50 to 85 wt. % water;
10 to 40 wt. % of a plant-based mixture of fatty acid triglycerides;
at least 1 wt. % of a starch and/or flour; and
at least 4 wt. % inulin.

In another embodiment, the present invention provides a method for the preparation of a plant-based cheese composition, as defined herein, comprising from 12 to 38 wt. % of a plant-based mixture of fatty acid triglycerides, preferably from 15 to 35 wt. %.

It was further found that the use of a plant-based mixture of fatty acid triglycerides which is solid at refrigerating temperatures, such as 2-7° C., in the method as described herein, is particularly suited to provide a plant-based cheese having the desired sensory characteristics. In a useful embodiment, the present invention provides a method for the preparation of a plant-based cheese composition, as defined herein, wherein the plant-based mixture of fatty acid triglycerides has a melting point of from 2 to 70° C., more preferably from 10 to 60° C., even more preferably from 15 to 50° C., yet even more preferably from 20 to 40° C.

In yet another embodiment, the present invention provides a method for the preparation of a plant-based cheese composition, as defined herein, wherein the plant-based mixture of fatty acid triglycerides is coconut oil, palm oil, a partially hydrogenated vegetable oil, a fully hydrogenated vegetable oil, or any combination thereof. In a particular embodiment, the present invention provides a method for the preparation of a plant-based cheese composition, as defined herein, wherein the plant-based mixture of fatty acid triglycerides consists of coconut oil.

In another embodiment, the present invention provides a method for the preparation of a plant-based cheese composition, as defined herein, wherein the emulsion further comprises from 0.5 to 10 wt. % of a vegetable protein, preferably from 1 to 8 wt. %, more preferably from 2 to 6 wt. %, even more preferably from 3 to 5 wt. % of a vegetable protein.

In yet another embodiment, the present invention provides a method for the preparation of a plant-based cheese composition, as defined herein, wherein the starch and/or flour, the inulin and the optional vegetable protein are provided as particulate matter.

In yet another embodiment, the present invention provides a method for the preparation of a plant-based cheese composition, as defined herein, wherein when both the vegetable protein and the starch and/or flour are provided, then they are provided separately, or as a mixture.

In yet another embodiment, the present invention provides a method for the preparation of a plant-based cheese composition, as defined herein, wherein the emulsion further comprises up to about 1 wt. % of an emulsifier, preferably up to about 0.5 wt. %, more preferably up to about 0.1 wt. %.

The present invention further provides a food product comprising the invented plant-based cheese composition and embodiments thereof.

The invention will now be described by reference to the below Examples and to the figures attached to this application, without being limited thereto.

In the Figures,

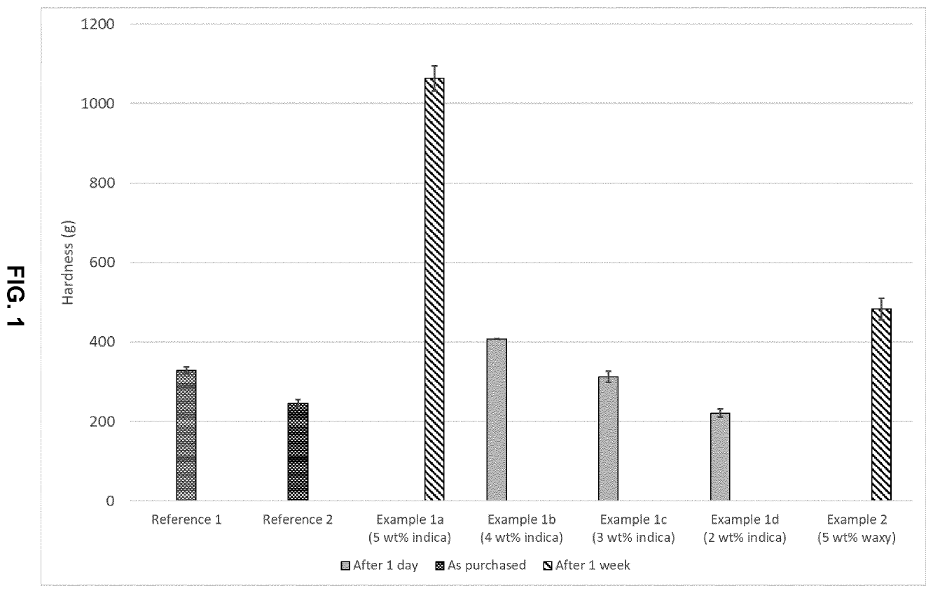

FIG. 1 shows the results of hardness measurements as referred to in Examples 1 and 2;

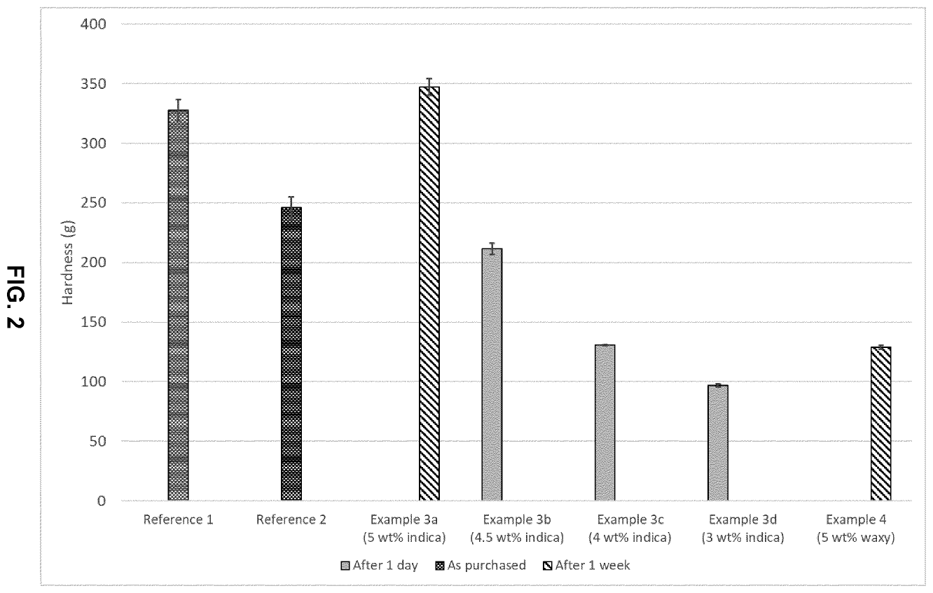

FIG. 2 shows the results of hardness measurements as referred to in Examples 3 and 4;

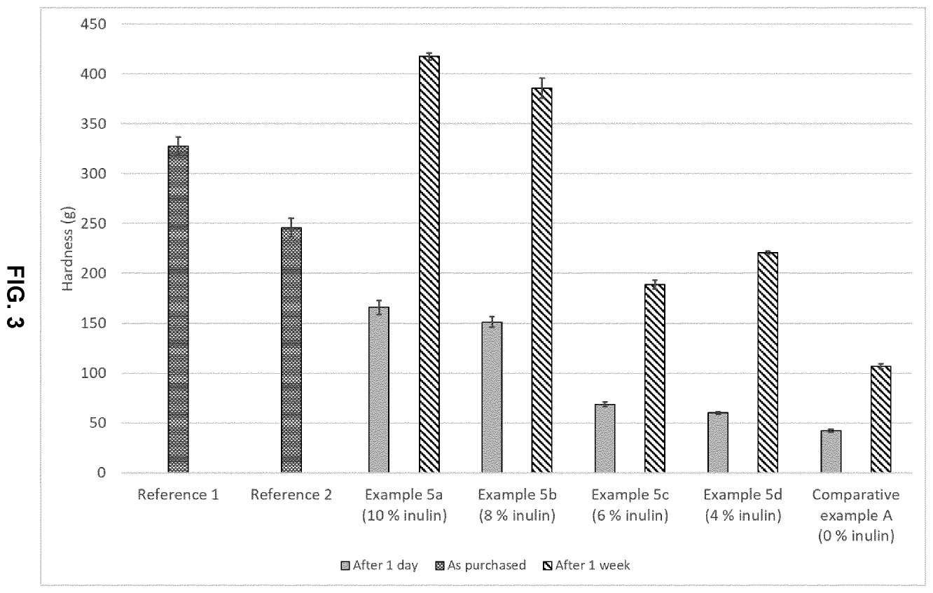

FIG. 3 shows the results of hardness measurements as referred to in Example 5;

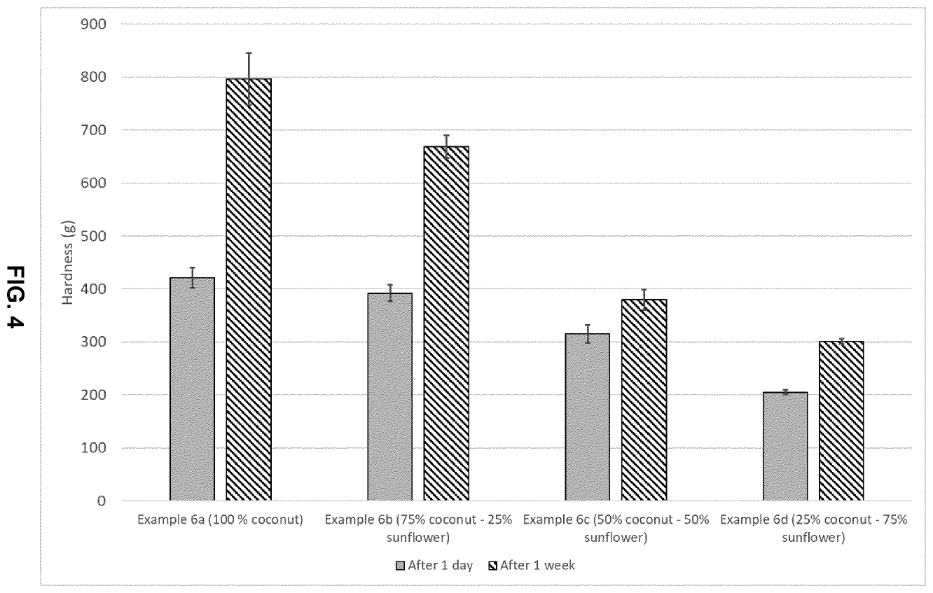

FIG. 4 shows the results of hardness measurements as referred to in Example 6;

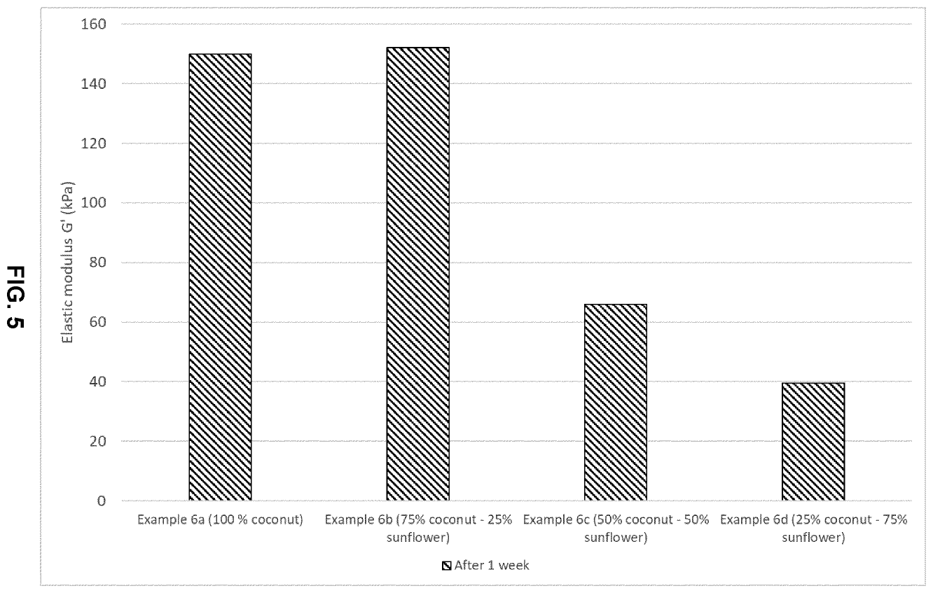

FIG. 5 shows the results of Elastic modulus measurements as referred to in Example 6.

### EXAMPLES

### Materials

The following materials were used in the following examples, unless stated otherwise.

Pea protein was sourced from Roquette. Inulin (Orafti®HPX) with an average degree of polymerization DP of 27, indica-type rice starch (Remy B7), waxy-type rice starch (Remyline XS), rice flour (Remyflo R7 90 T CP), faba bean flour (BeneoPro FB F30), faba bean starch rich flour (BeneoPro FB F20) and faba bean protein concentrate (BeneoPro FB P60) were sourced from Beneo. Non-hydrogenated RBD coconut oil, with a melting point of 25° C., was obtained from Marma (Nutribel). Non-hydrogenated sunflower oil, with a melting point of −17° C., was obtained from Vandemoortele. Pectin and carrageenan were sourced from CP Kelco. Lactic acid esters of mono- and diglycerides of fatty acids were obtained from Palsgaard. Flavouring was sourced from Givaudan. Lactic acid was obtained from Corbion.

### Methods

### General Procedure A: Hardness

Sensorial properties of samples of the plant-based cheese compositions were determined at 5° C. at different time points through a standard Texture Profile Analysis using a Stable Microsystems TA.HD plus, fitted with a 5 kg load cell and a P/0.5R probe. Samples were stored at 5° C. The test speed was 2 mm/s, and the test distance was set at 5 mm. The deformation curve of the sample was obtained, from which the parameter Force 1 (g) was determined in function of time(s), according to the manufacturer's protocol.

From these parameters, the following properties were calculated:

Hardness=peak force (g) of Force 1. The values shown are the average of three measurements.

### General Procedure B: Firmness, Yield Stress and Yield Strain

Rheological properties of samples of the plant-based cheese compositions were determined at 5° C. at different time points using a Physica MCR101 (Anton Paar) rheometer, equipped with a plate and PP40 spindle. Samples were stored at 5° C. The frequency was 1 Hz, and the strain was increased from 0.01 to 1000% (31 measuring points).

From these parameters, the following properties were calculated:
Elastic modulus G′ (Pa), related to the firmness of the samples;
Yield stress (−) and yield strain (Pa), related to the spreadability of the samples.

### Examples 1a-1d

These examples provide a plant-based cream cheese based on the indica-type rice starch and the inulin.

### Composition

The composition according to examples 1a-1d is shown in Table 1. To determine the effect of the amount of rice starch, its amount was varied.

TABLE 1
Composition of Examples 1a-1d

| | Example | Example | Example | Example |
|---|---|---|---|---|
| Ingredients | 1a (wt. %) | 1b (wt. %) | 1c (wt. %) | 1d (wt. %) |
| Water | 60.55 | 61.55 | 62.55 | 63.55 |
| Coconut oil | 20.00 | 20.00 | 20.00 | 20.00 |
| Inulin | 10.00 | 10.00 | 10.00 | 10.00 |
| Indica-type rice starch | 5.00 | 4.00 | 3.00 | 2.00 |
| Rice flour | 2.00 | 2.00 | 2.00 | 2.00 |
| Pectin | 0.85 | 0.85 | 0.85 | 0.85 |
| Carrageenan | 0.60 | 0.60 | 0.60 | 0.60 |
| Lecithin | 0.50 | 0.50 | 0.50 | 0.50 |
| Salt | 0.50 | 0.50 | 0.50 | 0.50 |
| Lactic acid | q.s. | q.s. | q.s. | q.s. |
| Total | 100.00 | 100.00 | 100.00 | 100.00 |

### Preparation

The plant-based cheese composition of each of examples 1a-1d was prepared by:
melting the coconut oil;
mixing all other powder ingredients;
adding the melted coconut and the mixed powder ingredients to water, while stirring and heating to 85° C.;
adjusting the pH with lactic acid to approximately 4.5;
pasteurisation at 85° C. for about 5 min;
homogenisation at 200 bar and 65° C.;
hot filling the emulsion in a mold and allowing the emulsion to cool down.

### Example 2

This example provides a plant-based cream cheese based on the waxy-type rice starch and the inulin.

### Composition

The composition according to example 2 is shown in Table 2. By changing the indica-type rice starch to a waxy-type rice starch, its influence could be determined.

TABLE 2
Composition of Example 2

| Ingredients | Example 2 (wt. %) |
|---|---|
| Water | 60.55 |
| Coconut oil | 20.00 |
| Inulin | 10.00 |
| Waxy-type rice starch | 5.00 |
| Rice flour | 2.00 |
| Pectin | 0.85 |
| Carrageenan | 0.60 |
| Lecithin | 0.50 |
| Salt | 0.50 |
| Lactic acid | q.s. |
| Total | 100.00 |

### Preparation

The plant-based cheese composition of example 2 was prepared according to example 1.

### Evaluation

The plant-based cheese compositions of examples 1a-1d and example 2 were evaluated by determining the hardness according to General procedure A. Examples 1b-1d were evaluated after 1 day at refrigeration temperature, while examples 1a and 2 were evaluated after 1 week at refrigeration temperature.

The hardness of two commercial milk-based cream cheeses, a first one with a fat content of approximately 20 wt. % (reference 1), and a second one with a fat content of approximately 10 wt. % (reference 2), was also determined according to the same procedure after purchase.

FIG. 1 provides an overview of the hardness of both references, examples 1a-1d, and example 2.

The plant-based cheese compositions of examples 1a-1d and example 2 were also qualitatively assessed to determine their sensorial characteristics after 1 day at refrigeration temperature.

Table 3 provides the results of the qualitative assessment of the plant-based cheese compositions of examples 1a-1d and example 2 in terms of 1) taste, 2) texture, 3) mouthfeel, and 4) appearance. The sensorial evaluation was scored for each of the sensorial characteristics from undesirable (−), over slightly undesirable (+), desirable (++), to highly desirable (+++).

TABLE 3
Results of sensorial evaluation of Examples 1a-1d & 2

| | Taste | Texture | Mouthfeel | Appearance |
|---|---|---|---|---|
| Example 1a | ++ | ++ | ++ | +++ |
| Example 1b | ++ | ++ | +++ | +++ |
| Example 1c | +++ | +++ | +++ | +++ |
| Example 1d | +++ | +++ | +++ | +++ |
| Example 2 | + | ++ | + | +++ |

The plant-based cheese composition of example 1a (5% indica-type rice starch) had a good spreadable, dry texture, a butter-like consistency, a neutral taste and a more chewy mouthfeel. The plant-based cheese composition of example 1b (4% indica-type rice starch) had a good spreadable, elastic texture, a slight coconut taste and a smooth mouthfeel. The plant-based cheese composition of example 1c (3% indica-type rice starch) had a good spreadable, softer texture, a neutral taste and a smooth mouthfeel. The plant-based cheese composition of example 1d (2% indica-type rice starch) had a good spreadable, firmer texture, a neutral taste and a smooth and creamy mouthfeel. The plant-based cheese composition of example 2 (5% waxy-type rice starch) had a good spreadable, sticky texture, a coconut oil taste and a neutral mouthfeel.

When comparing the texture of the indica-type rice starch and the waxy-type rice starch, the former had a shorter and firmer texture, while the latter tended to have a stickier texture at higher amounts. In a sensorial evaluation the indica-type rice starch received more acclaim.

### Examples 3a-3d

These examples provide a plant-based cream cheese based on the indica-type rice starch and the inulin, with a reduced fat content in comparison with examples 1a-1d.

### Composition

The composition according to examples 3a-3b is shown in Table 4. By lowering the amount of coconut oil, and varying the amount of indica-type rice starch, its influence could be determined.

TABLE 4
Composition of Examples 3a-3d

| | Example | Example | Example | Example |
|---|---|---|---|---|
| Ingredients | 3a (wt. %) | 3b (wt. %) | 3c (wt. %) | 3d (wt. %) |
| Water | 70.55 | 71.05 | 71.55 | 72.55 |
| Coconut oil | 10.00 | 10.00 | 10.00 | 10.00 |
| Inulin | 10.00 | 10.00 | 10.00 | 10.00 |
| Indica-type rice starch | 5.00 | 4.50 | 4.00 | 3.00 |
| Rice flour | 2.00 | 2.00 | 2.00 | 2.00 |
| Pectin | 0.85 | 0.85 | 0.85 | 0.85 |
| Carrageenan | 0.60 | 0.60 | 0.60 | 0.60 |
| Lecithin | 0.50 | 0.50 | 0.50 | 0.50 |
| Salt | 0.50 | 0.50 | 0.50 | 0.50 |
| Lactic acid | q.s. | q.s. | q.s. | q.s. |
| Total | 100.00 | 100.00 | 100.00 | 100.00 |

### Preparation

The plant-based cheese compositions of examples 3a-3d were prepared according to example 1.

### Example 4

This example provides a plant-based cream cheese based on the waxy-type rice starch and the inulin, with a reduced fat content in comparison with example 2.

### Composition

The composition according to example 4 is shown in Table 5. By changing the indica-type rice starch to a waxy-type rice starch, its influence could be determined.

TABLE 5
Composition of Example 4

| Ingredients | Example 4 (wt. %) |
|---|---|
| Water | 70.55 |
| Coconut oil | 10.00 |
| Inulin | 10.00 |
| Waxy-type rice starch | 5.00 |
| Rice flour | 2.00 |
| Pectin | 0.85 |
| Carrageenan | 0.60 |
| Lecithin | 0.50 |
| Salt | 0.50 |
| Lactic acid | q.s. |
| Total | 100.00 |

### Preparation

The plant-based cheese composition of example 4 was prepared according to example 1.

### Evaluation

The plant-based cheese compositions of examples 3a-3d and example 4 were evaluated by determining the hardness according to General procedure A. Examples 3b-3d were evaluated after 1 day at refrigeration temperature, while examples 3a and 4 were evaluated after 1 week at refrigeration temperature.

FIG. 2 provides an overview of the hardness of both references, examples 3a-3d, and example 4.

The plant-based cheese compositions of examples 3a-3d and example 4 were also qualitatively assessed to determine their sensorial characteristics after 1 day at refrigeration temperature.

Table 6 provides the results of the qualitative assessment of the plant-based cheese compositions of examples 3a-3d and example 4 according to the evaluation of examples 1a-1d and example 2.

TABLE 6
Results of sensorial evaluation of Examples 3a-3d & 4

| | Taste | Texture | Mouthfeel | Appearance |
|---|---|---|---|---|
| Example 3a | ++ | + | ++ | +++ |
| Example 3b | ++ | +++ | ++ | +++ |
| Example 3c | ++ | ++ | ++ | +++ |
| Example 3d | ++ | ++ | +++ | +++ |
| Example 4 | ++ | + | ++ | +++ |

The plant-based cheese composition of example 3a (5% indica-type rice starch) had a less spreadable, gummy texture, a neutral taste and a neutral mouthfeel. The plant-based cheese composition of example 3b (4.5% indica-type rice starch) had a good spreadable, slightly elastic texture, a neutral taste and a slightly sticky mouthfeel. The plant-based cheese composition of example 3c (4% indica-type rice starch) had a quite soft, spreadable texture, a neutral taste and a creamy, salty, slightly sticky mouthfeel. The plant-based cheese composition of example 3d (3% indica-type rice starch) had a quite soft, spreadable, an acceptable taste and a creamy mouthfeel. The plant-based cheese composition of example 4 (5% waxy-type rice starch) had a soft, less spreadable texture, a less pronounced coconut oil taste compared to example 2, and a neutral mouthfeel.

### Examples 5a-5d & Comparative Example 1

This example provides a plant-based cream cheese based on the indica-type rice starch, with or without the inulin.

### Composition

In examples 5a-5d rice flour was replaced with additional indica-type rice starch. To determine the effect of the amount of inulin, its amount was varied. The composition according to examples 5a-5d and comparative example A is shown in Table 7.

TABLE 7
Composition of Examples 5a-5d and Comparative example A

| | | | | | Comp |
|---|---|---|---|---|---|
| | Example | Example | Example | Example | example |
| Ingredients | 5a (wt. %) | 5b (wt. %) | 5c (wt. %) | 5d (wt %) | A (wt. %) |
| Water | 71.55 | 73.55 | 75.55 | 77.55 | 81.55 |
| Coconut oil | 10.00 | 10.00 | 10.00 | 10.00 | 10.00 |
| Inulin | 10.00 | 8.00 | 6.00 | 4.00 | 0.00 |
| Indica-type | 6.00 | 6.00 | 6.00 | 6.00 | 6.00 |
| rice starch | | | | | |
| Pectin | 0.85 | 0.85 | 0.85 | 0.85 | 0.85 |
| Carrageenan | 0.60 | 0.60 | 0.60 | 0.60 | 0.60 |
| Lecithin | 0.50 | 0.50 | 0.50 | 0.50 | 0.50 |
| Salt | 0.50 | 0.50 | 0.50 | 0.50 | 0.50 |
| Flavour | 0.00 | 0.00 | 0.00 | 0.00 | 0.00 |
| Lactic acid | q.s. | q.s. | q.s. | q.s. | q.s. |
| Total | 100.00 | 100.00 | 100.00 | 100.00 | 100.00 |

### Preparation

The plant-based cheese compositions of examples 5a-5d and comparative example A were prepared according to example 1.

### Evaluation

The plant-based cheese compositions of examples 5a-5d and comparative example A were evaluated by determining the hardness according to General procedure A after 1 day and 1 week at refrigeration temperature. As shown in FIG. 3, when at least 4 wt. % inulin is present in the plant-based composition, the hardness of the resulting plant-based cheese (examples 5a-5d) is significantly improved compared to a plant-based cheese without inulin (comparative example A). The hardness after 1 week is moreover comparable to the tested commercial milk-based cream cheeses (reference 1-2).

### Examples 6a-6d-Plant-Based (Processed) Cheesecake Base

These examples provide a plant-based cheesecake base based on an indica-type rice starch and an inulin.

### Composition

To prepare a cheesecake base, besides indica-type rice starch and rice flour, also pea protein was added. The effect of the saturated fatty acid content of the plant-based mixture of fatty acid triglycerides was determined by varying the amount of coconut oil, sunflower oil, and mixtures thereof. The composition according to examples 6a-6d is shown in Table 8.

TABLE 8
Composition of Examples 6a-6d

| | Example | Example | Example | Example |
|---|---|---|---|---|
| Ingredients | 6a (wt. %) | 6b (wt. %) | 6c (wt. %) | 6d (wt. %) |
| Water | 51.20 | 51.20 | 51.20 | 51.20 |
| Coconut oil | 34.00 | 25.50 | 17.00 | 8.50 |
| Sunflower oil | 0.00 | 8.50 | 17.00 | 25.50 |
| Inulin | 8.00 | 8.00 | 8.00 | 8.00 |
| Pea protein | 1.50 | 1.50 | 1.50 | 1.50 |
| Indica-type rice starch | 1.30 | 1.30 | 1.30 | 1.30 |
| Rice flour | 1.30 | 1.30 | 1.30 | 1.30 |
| Pectin | 0.85 | 0.85 | 0.85 | 0.85 |
| Carrageenan | 0.60 | 0.60 | 0.60 | 0.60 |
| Lactic acid esters of | 0.75 | 0.75 | 0.75 | 0.75 |
| mono-and diglycerides | | | | |
| of fatty acids | | | | |
| Salt | 0.50 | 0.50 | 0.50 | 0.50 |
| Lactic acid | q.s. | q.s. | q.s. | q.s. |
| Total | 100.00 | 100.00 | 100.00 | 100.00 |

### Preparation

The plant-based cheese compositions of examples 6a-6d were prepared according to example 1. When a mixture coconut oil and sunflower oil was used, the coconut oil was melted and both oils were added to the water with the pre-mix.

### Evaluation

The plant-based cheese compositions of examples 6a-6d were evaluated by determining the hardness according to General procedure A after 1 day and 1 week at refrigeration temperature, and the firmness and yield stress/strain according to General procedure B after 1 week at refrigeration temperature. A set of sensorial characteristics was also evaluated based on a qualitative analysis after 1 day at refrigeration temperature.

Table 9 provides the results of the qualitative analysis according to the evaluation of examples 1a-1d and example 2.

TABLE 9
Results of sensorial evaluation of Examples 6a-6d

| | Taste | Texture | Mouthfeel | Appearance |
|---|---|---|---|---|
| Example 6a | +++ | +++ | +++ | +++ |
| Example 6b | ++ | +++ | ++ | +++ |
| Example 6c | + | ++ | ++ | +++ |
| Example 6d | + | + | + | +++ |

The plant-based cheese composition of example 6a (100% coconut oil) had a neutral taste, a firm texture, a smooth, slow melting mouthfeel and a white, glossy appearance. The plant-based cheese composition of example 6b (75% coconut oil/25% sunflower oil) had a slight taste difference compared to example 6a, a slightly less firm texture, a smooth, slightly fatty mouthfeel and a white, glossy appearance. The plant-based cheese composition of example 6c (50% coconut oil/50% sunflower oil) had a more noticeable sunflower oil taste compared to example 6b, a softer texture, a smooth mouthfeel with a more noticeable fat film and a white, glossy appearance. The plant-based cheese composition of example 6d (25% coconut oil/75% sunflower oil) had a clear sunflower oil taste, an even softer texture, a smooth mouthfeel with clear fat formation and a white, glossy appearance.

FIG. 4 provides an overview of the hardness of examples 6a-6d after 1 week at refrigeration temperature. As shown in FIG. 4, a higher amount of saturated fatty acids in the plant-based mixture of fatty acid triglycerides present in the plant-based cheese composition lead to an increase in hardness. FIG. 5 shows the elastic modulus G′ in the linear viscoelastic region of a gel of examples 6a-6d after 1 week at refrigeration temperature, which is related to the firmness of the samples. It is shown in FIG. 5 that a higher amount of saturated fatty acids in the plant-based mixture of fatty acid triglycerides present in the plant-based cheese composition lead to an increase in firmness. Finally, it is known that the yield stress/yield strain value of a product is known to be related to its spreadability. The lower the yield stress and/or the higher the yield strain, the more spreadable the product becomes. It was found that examples 6c and 6d had a similar yield stress of about 30 Pa, while examples 6a and 6b had a similar yield stress of about 60 Pa. Based on these examples, it is therefore shown that a lower amount of saturated fatty acids in the plant-based mixture of fatty acid triglycerides present in the plant-based cheese composition may lead to an improved spreadability.

### Example 7

This example provides a plant-based feta type cheese.

### Composition

The composition according to example 7 was based on a combination of an inulin, an indica-type rice starch, a rice flour and a faba bean protein concentrate, as shown in Table 10. Due to the presence of carrageenan and pectin, this concept is described as “processed”.

TABLE 10
Composition of Example 7

| Ingredients | Example 7 (wt. %) |
|---|---|
| Water | 59.05 |
| Coconut oil | 20.00 |
| Inulin | 10.00 |
| Indica-type rice starch | 6.00 |
| Rice flour | 2.00 |
| Faba bean protein concentrate | 1.00 |
| Pectin | 0.85 |
| Carrageenan | 0.60 |
| Salt | 0.50 |
| Flavour | q.s. |
| Lactic acid | q.s. |
| Total | 100.00 |

### Preparation

The plant-based cheese composition of example 7 was prepared according to example 1.

### Example 8

This example provides a plant-based feta type cheese.

### Composition

The composition according to example 8 was based on a combination of an inulin, an indica-type rice starch, a rice flour and a faba bean protein concentrate, as shown in Table 11. By increasing the amount of the indica-type rice starch, the added stabilizers, such as carrageenan and pectin, were made redundant, resulting in a “clean label” concept.

TABLE 11
Composition of Example 8

| Ingredients | Example 8 (wt. %) |
|---|---|
| Water | 56.00 |
| Coconut oil | 20.00 |
| Inulin | 10.00 |
| Rice starch | 10.00 |
| Rice flour | 2.00 |
| Faba bean protein concentrate | 1.00 |
| Pectin | 0.00 |
| Carrageenan | 0.00 |
| Salt | 1.00 |
| Flavour | q.s. |
| Lactic acid | q.s. |
| Total | 100.00 |

### Preparation

The plant-based cheese composition of example 8 was prepared according to example 1.

### Example 9

This example provides a plant-based feta type cheese.

### Composition

The composition according to example 9 was based on a combination of an inulin, a faba bean starch rich flour, a rice flour and a faba bean protein concentrate, as shown in Table 12, thereby providing another “clean label” concept.

TABLE 12
Composition of Example 9

| Ingredients | Example 9 (wt. % ) |
|---|---|
| Water | 56.00 |
| Coconut oil | 20.00 |
| Inulin | 10.00 |
| Faba bean starch rich flour | 10.00 |
| Rice flour | 2.00 |
| Faba bean protein concentrate | 1.00 |
| Pectin | 0.00 |
| Carrageenan | 0.00 |
| Salt | 1.00 |
| Flavour | q.s. |
| Lactic acid | q.s. |
| Total | 100.00 |

### Preparation

The plant-based cheese composition of example 9 was prepared according to example 1.

### Example 10

This example provides a plant-based cheese.

### Composition

The composition according to Example 10 was based on a combination of an inulin, a faba bean protein concentrate and a rice flour as shown in Table 13. The rice flour used in Example 10 was a dry-milled indica-type rice flour having a particle size, expressed as D90, of about 50 micron.

The effect of the rice flour compared to a combination of rice flour and rice starch was demonstrated by comparing the plant-based cheese compositions of Example 10 and Example 8.

TABLE 13
Composition of Example 10

| Ingredients | Example 10 (wt. %) |
|---|---|
| Water | 56.00 |
| Coconut oil | 20.00 |
| Inulin | 10.00 |
| Rice flour | 12.00 |
| Faba bean protein concentrate | 1.00 |
| Pectin | 0.00 |
| Carrageenan | 0.00 |
| Salt | 1.00 |
| Flavour | q.s. |
| Lactic acid | q.s. |
| Total | 100.00 |

### Preparation

The plant-based cheese composition of example 10 was prepared according to example 1.

### Example 11

This example provides a plant-based Camembert type cheese.

### Composition

The composition according to example 11 was based on a combination of an inulin, a faba bean flour and a rice flour, as shown in Table 14, thereby providing another “clean label” concept.

TABLE 13
Composition of Example 11

| Ingredients | Example 11 (wt. %) |
|---|---|
| Water | 55.00 |
| Coconut oil | 20.00 |
| Inulin | 10.00 |
| Faba bean flour | 12.00 |
| Rice flour | 2.00 |
| Pectin | 0.00 |
| Carrageenan | 0.00 |
| Salt | 1.00 |
| Flavour | q.s. |
| Lactic acid | q.s. |
| Total | 100.00 |

### Preparation

The plant-based cheese composition of example 11 was prepared according to example 1.

### Example 12

This example provides a plant-based Kiri type cheese.

### Composition

The composition according to example 12 was based on a combination of an inulin, an indica-type rice starch, a rice flour and a faba bean protein concentrate, as shown in Table 15, thereby providing another “clean label” concept.

TABLE 14
Composition of Example 12

| Ingredients | Example 12 (wt. %) |
|---|---|
| Water | 55.90 |
| Coconut oil | 20.00 |
| Inulin | 10.00 |
| Indica-type rice starch | 6.50 |
| Rice flour | 2.00 |
| Faba bean protein concentrate | 4.60 |
| Pectin | 0.00 |
| Carrageenan | 0.00 |
| Salt | 1.00 |
| Flavour | q.s. |
| Lactic acid | q.s. |
| Total | 100.00 |

### Preparation

The plant-based cheese composition of example 12 was prepared according to example 1.

1. A plant-based cheese composition comprising;
50 to 85 wt. % water;
10 to 40 wt. % of a plant-based mixture of fatty acid triglycerides;
at least 1 wt. % of a starch and/or flour; and
at least 4 wt. % inulin.

2. The plant-based cheese composition as claimed in claim 1, wherein the inulin has an average degree of polymerization D̅P̅ from 8 to 60, preferably from 12 to 50, more preferably from 15 to 40.

3. The plant-based cheese composition as claimed in claim 1, comprising from 5 to 15 wt. % inulin, preferably from 6 to 12 wt. %.

4. The plant-based cheese composition as claimed in claim 1, comprising a combined amount of starch and/or flour of from 2 to 20 wt. %, preferably from 3 to 15 wt. %, more preferably from 4 to 12 wt. %.

5. The plant-based cheese composition as claimed in claim 1, wherein the saturated fatty acid content of the plant-based mixture of fatty acid triglycerides, relative to the total fatty acid content, is at least 20 wt. %, preferably at least 30 wt. %, more preferably at least 40 wt. %, even more preferably at least 50 wt. %, yet even more preferably from 60 to 95 wt. %, most preferably from 70 to 90 wt. %.

6. The plant-based cheese composition as claimed in claim 1, further comprising from 0.5 to 10 wt. % of a vegetable protein, preferably from 1 to 8 wt. %, more preferably from 2 to 6 wt. %, even more preferably from 3 to 5 wt. % of a vegetable protein.

7. The plant-based cheese composition as claimed in claim 1, wherein the starch is selected from indica-type rice starch, faba bean starch, or any combination thereof; and/or wherein the flour is selected from a rice flour, a faba bean flour or any combination thereof.

8. The plant-based cheese composition as claimed in claim 1, wherein the vegetable protein is selected from pea protein, rice protein, faba bean protein, fava protein, or any combination thereof.

9. The plant-based cheese composition as claimed in claim 1, comprising:
50 to 85 wt. % water;
10 to 40 wt. % of a plant-based mixture of fatty acid triglycerides;
at least 1 wt. % of a flour, preferably a rice flour; and
at least 4 wt. % inulin.

10. A method for the preparation of a plant-based cheese composition as defined in claim 1, comprising the steps of;
a) stirring a mixture of the plant-based mixture of fatty acid triglycerides, the starch and/or flour, the inulin, and optionally the vegetable protein, flavoring agents, colorants, stabilizers, emulsifiers and/or other additives in water at a temperature of at least 10° C., and above the melting point of the plant-based mixture of fatty acid triglycerides, thereby providing an emulsion;
b) homogenizing the emulsion by subjecting the emulsion to shear forces, thereby providing a homogenized emulsion;
c) optionally hot filling the homogenized emulsion in a mold; and
d) cooling down the homogenized emulsion, thereby providing a plant-based cheese composition;
wherein the emulsion comprises:
50 to 85 wt. % water;
10 to 40 wt. % of a plant-based mixture of fatty acid triglycerides;
at least 1 wt. % of a starch and/or flour; and
at least 4 wt. % inulin.

11. The method as claimed in claim 10, further comprising the step of adding the plant-based mixture of fatty acid triglycerides to the water thereby obtaining a pre-mixture, before the starch and/or flour, the inulin, and optionally the vegetable protein, flavoring agents, colorants, stabilizers, emulsifiers and/or other additives are added thereto.

12. The method as claimed in claim 10, further comprising the step of mixing the starch and/or flour, the inulin, and optionally the vegetable protein, flavoring agents, colorants, stabilizers, emulsifiers and/or other additives, thereby providing a inulin/starch and/or flour mixture, which is added to the water.

13. The method as claimed in claim 12, further comprising the step of adding the inulin/starch and/or flour mixture to the pre-mixture.

14. The method as claimed in claim 10, wherein stirring the mixture in step a) is performed at a temperature of at least 20° C., preferably at least 30° C., more preferably from 40 to 90° C., even more preferably at a temperature from 50 to 80° C.

15. A food product comprising a plant-based cheese composition, as defined in claim 1.
